(19) United States
(12) Patent Application Publication
(10) Pub. No.: US 2003/0042326 A1
(43) Pub. Date: Mar. 6, 2003

(54) Apparatus and method to selectively microemulsify water and other normally immiscible fluids into the fuel of continuous combustors at the point of injection

(75) Inventors: Lee K. Jameson, Roswell, GA (US); Bernard Cohen, Berkeley Lakes, GA (US); Lamar Heath Gipson, Acworth, GA (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/010,442

(22) Filed: Nov. 8, 2001

Related U.S. Application Data
(60) Provisional application No. 60/258,194, filed on Dec. 22, 2000.

(51) Int. Cl. B05B 1/08

(52) U.S. Cl. 239/102.2

(57) ABSTRACT

An ultrasonically enhanced continuous flow apparatus for selectively microemulsifying water and other normally immiscible fluids into the fuel of continuous combustors at the point of injection and a method for the same is disclosed. The apparatus includes an injector housing which in part defines a chamber adapted to receive a pressurized liquid and a means for applying ultrasonic energy to a portion of the pressurized liquid. The injector housing further includes an inlet adapted to supply the chamber with the pressurized liquid, and an exit orifice defined by the walls of an injector tip. The exit orifice is adapted to receive the pressurized liquid from the chamber via a vestibular cavity and pass the liquid out of the injector housing in the form of an emulsified, atomized plume. When the means for applying ultrasonic energy is excited, it applies ultrasonic energy to the pressurized liquid without mechanically vibrating the injector tip. The method involves supplying a pressurized liquid to the foregoing apparatus, applying ultrasonic energy to the pressurized liquid while not mechanically vibrating the injector tip while the exit orifice receives pressurized liquid from the chamber, and passing the pressurized liquid out of the exit orifice in the injector tip.

### BACKGROUND OF THE INVENTION

The present invention relates to an apparatus for selectively microemulsifying water and other normally immiscible fluids into the fuel of continuous combustors at the point of injection. The present invention further relates to a method for selectively microemulsifying water and other normally immiscible fluids into the fuel of continuous combustors at the point of injection.

### SUMMARY OF THE INVENTION

The present invention provides an ultrasonic apparatus and a method for selectively microemulsifying water and other normally immiscible fluids into the fuel of continuous combustors at the point of injection, i.e., just prior to injecting the fuel into a continuous combustor. Examples of such combustors include, but are not limited to, domestic and industrial furnaces, boilers, kilns, incinerators thrust output gas turbines, and shaft output gas turbines, including stationary, marine, or aircraft.

The apparatus includes an injector housing, which in part defines a chamber adapted to receive an admixture containing a pressurized liquid fuel and an immiscible fluid, hereafter alternatively referred to as the admixture or the fuel admixture. The apparatus further comprises a means for applying ultrasonic energy to a portion of the fuel admixture. The injector housing includes a chamber adapted to receive the fuel admixture, an inlet adapted to supply the chamber with the fuel admixture, an injector tip, hereinafter referred to as an injector tip, and an exit orifice (or a plurality of exit orifices) defined by the walls of the injector tip and adapted to receive the fuel admixture from the chamber and pass the liquid fuel out of the injector housing desirably in the form of an atomized plume.

A vestibular cavity is also defined by the walls of the injector tip. The vestibular cavity receives the liquid fuel admixture directly from the chamber and passes that fuel to the exit orifice. The means for applying ultrasonic energy is located within the chamber in close proximity to the vestibular cavity, and may be, for example, an immersed ultrasonic horn. According to the invention, the means for applying ultrasonic energy is located within the chamber in a manner such that no mechanical vibrational energy is applied to the injector tip (i.e., to the walls of the injector tip defining the exit orifice).

In one embodiment of the ultrasonic fuel injector apparatus, the injector housing may have a first end and a second end and the exit orifice is adapted to receive the fuel admixture from the chamber and pass the fuel admixture along a first axis. The means for applying ultrasonic energy to a portion of the fuel admixture is an ultrasonic horn having a first end and a second end. The horn is adapted, upon excitation by ultrasonic energy, to have a node and a longitudinal mechanical excitation axis. The horn is located in the second end of the injector housing in a manner such that the first end of the horn is located outside of the injector housing and the second end is located inside the injector housing, within the chamber the second end is in close proximity to the vestibular cavity and is substantially aligned along the longitudinal mechanical excitation axis with a central axis of the vestibular cavity. The horn is preferably secured to the injector housing at the node. Alternatively, both the first end and the second end of the horn may be located inside the injector housing.

The longitudinal excitation axis of the ultrasonic horn desirably will be substantially parallel with the first axis. Furthermore, the second end of the horn desirably will have a cross-sectional area approximately the same as or greater than a minimum area which encompasses the area defining the opening to the vestibular cavity in the injector housing. It is believed that this configuration focuses the ultrasonic energy into the liquid reservoir contained within the vestibular cavity.

The ultrasonic fuel injector apparatus may have an ultrasonic horn having a vibrator means coupled to the first end of the horn. The vibrator means may be a piezoelectric transducer or a magnetostrictive transducer. The transducer may be coupled directly to the horn or by means of an elongated waveguide. The elongated waveguide may have any desired input:output mechanical excitation ratio, although ratios of 1:1 and 1:1.5 are typical for many applications. The ultrasonic energy typically will have a frequency of from about 15 kHz to about 500 kHz, although other frequencies are contemplated.

In an embodiment of the present invention, the ultrasonic horn may be composed partially or entirely of a magnetostrictive material. The horn may be surrounded by a coil (which may be immersed in the liquid) capable of inducing a signal into the magnetostrictive material causing it to vibrate at ultrasonic frequencies. In such cases, the ultrasonic horn may be simultaneously the transducer and the means for applying ultrasonic energy to the liquid fuel.

The apparatus includes an injector housing which in part defines a chamber adapted to receive a fuel admixture and a means for applying ultrasonic energy to a portion of the fuel admixture. The injector housing includes a chamber adapted to receive the fuel admixture, an inlet adapted to supply the chamber with the fuel admixture, an injector tip, and an exit orifice (or a plurality of exit orifices) defined by the walls of the injector tip, the exit orifice being adapted to receive the fuel admixture from the chamber and pass the fuel out of the injector housing.

Disposed between the chamber and the exit orifice, and defined by the walls of the injector tip is a vestibular cavity. The vestibular cavity serves as a reservoir for fuel received from the cavity. The vestibular cavity also serves as a focal point to which the ultrasonic energy is directed. From the vestibular chamber, the fuel excited by the application of ultrasonic energy is passed to the exit orifice.

Generally speaking, the means for applying ultrasonic energy is located within the chamber. For example, the means for applying ultrasonic energy may be an immersed ultrasonic horn. According to the invention, the means for applying ultrasonic energy is located within the chamber in a manner such that no mechanical vibrational energy is applied to the injector tip (i.e., the walls of the injector tip or nozzle defining the exit orifice).

In one embodiment of the present invention, the injector housing may have a first end and a second end. One end of the injector housing forms an injector tip or nozzle. Alternatively the injector housing may be adapted to receive a replaceable injector tip or nozzle. In either case, the injector tip has walls that define a vestibular cavity and an exit orifice adapted to receive the fuel admixture from the vestibular cavity and pass the fuel admixture along a first axis. The means for applying ultrasonic energy to a portion of the fuel admixture is an ultrasonic horn having a first end and a second end. The horn is adapted, upon excitation by ultrasonic energy, to have a node and a longitudinal mechanical excitation axis. The horn is located in the second end of the injector housing and is fastened at its node in a manner such that the first end of the horn is located outside of the injector housing and the second end is located inside the injector housing, within the chamber, and is in close proximity to the opening of the vestibular cavity in the injector tip.

The longitudinal excitation axis of the ultrasonic horn desirably will be substantially parallel with the first axis. Furthermore, the second end of the horn desirably will be substantially aligned along the longitudinal mechanical excitation axis with a central axis of the vestibular cavity and will have a cross-sectional area approximately the same as or greater than a minimum area which encompasses the area defining the opening to the vestibular cavity in the injector housing. Upon excitation by ultrasonic energy, the ultrasonic horn is adapted to apply ultrasonic energy to the fuel admixture within the vestibular cavity but not to transfer vibrational energy to the walls of the injector tip itself or to the exit orifice. Energy will be applied to the liquid fuel admixture within the chamber but the majority of the energy is directed into the reservoir of liquid fuel contained within the vestibular cavity and does not affect the injector tip or the exit orifice itself.

The present invention contemplates the use of an ultrasonic horn having a vibrator means coupled to the first end of the horn. The vibrator means may'be a piezoelectric transducer or a magnetostrictive transducer. The transducer may be coupled directly to the horn or by means of an elongated waveguide. The elongated waveguide may have any desired input:output mechanical excitation ratio, although ratios of 1:1 and 1:1.5 are typical for many applications. The ultrasonic energy typically will have a frequency of from about 15 kHz to about 500 kHz, although other frequencies are contemplated.

In an embodiment of the present invention, the ultrasonic horn may be partially or completely composed of a magnetostrictive material and be surrounded by a coil (which may be immersed in the liquid) capable of inducing a signal into the magnetostrictive material causing it to vibrate at ultrasonic frequencies. In such case, the ultrasonic horn may be simultaneously the transducer and the means for applying ultrasonic energy to a multi-component liquid fuel.

In an aspect of the present invention, the exit orifice may have a diameter of less than about 0.1 inch (2.54 mm). For example, the exit orifice may have a diameter of from about 0.0001 to about 0.1 inch (0.00254 to 2.54 mm) As a further example, the exit orifice may have a diameter of from about 0.001 to about 0.01 inch (0.0254 to 0.254 mm). The vestibular cavity may have a diameter of about 0.125 inch (about 3.2 mm) terminating in a convergent passageway which in turn leads to the exit orifice. The passageway may have frustoconical walls with about a 30 degree convergence as measured from a central axis coinciding with the first axis.

According to the invention, the exit orifice may be a single exit orifice or a plurality of exit orifices. The exit orifice may be an exit capillary. The exit capillary may have a length to diameter ratio (L/D ratio) of ranging from about 4:1 to about 10:1. Of course, the exit capillary may have a L/D ratio of less than 4:1 or greater than 10:1.

In an embodiment of the invention, the apparatus is adapted to produce a spray of liquid fuel. For example, the apparatus may be adapted to produce an atomized spray of liquid fuel. Alternatively and/or additionally, the apparatus may be adapted to produce a uniform, cone-shaped spray of liquid fuel. In another embodiment of the invention, the apparatus may be adapted to emulsify a pressurized multi-component liquid fuel. In another embodiment of the invention, the exit orifice is self-cleaning. In yet another embodiment of the invention, the apparatus may be adapted to cavitate a pressurized liquid.

The apparatus and method may be used in fuel injectors for liquid-fueled combustors. Exemplary combustors include, but are not limited to, boilers, kilns, industrial and domestic furnaces, incinerators. The apparatus and method may be used in fuel injectors for discontinuous flow internal combustion engines (e.g., reciprocating piston gasoline and diesel engines).

The apparatus and method may also be used in fuel injectors for continuous flow engines (e.g., Sterling-cycle heat engines and gas turbine engines).

The apparatus and method of the present invention may be used to emulsify multi-component liquid fuels as well as liquid fuel additives and contaminants, whether they be liquid or gaseous, at the point where the liquid fuels are introduced into the combustor (e.g., internal combustion engine). For example, water entrained in certain fuels may be emulsified so that fuel/water mixture may be used in the combustor. Mixed fuels and/or fuel blends including components such as, for example, methanol, water, 'ethanol, diesel, liquid propane gas, bio-diesel or the like can also be emulsified. The present invention can have advantages in multi-fueled engines in that it may be used to compatibalize the flow rate characteristics (e.g., apparent viscosities) of the different fuels that may be used in the multi-fueled engine.

Alternatively and/or additionally, it may be desirable to add water to one or more liquid fuels and emulsify the components immediately before combustion as a way of controlling combustion and/or reducing exhaust emissions. It may also be desirable to add a gas (e.g., air, N₂O, etc.) to one or more liquid fuels and ultrasonically blend or emulsify the components immediately before combustion as a way of controlling combustion and/or reducing exhaust emissions.

### BRIEF DESCRIPTION OF THE DRAWINGS

FIG. 1 is a diagrammatic cross-sectional representation of one embodiment of the apparatus of the present invention.

FIG. 2 is an illustration of a device used to measure the force or impulse of droplets in a water plume injected into the atmosphere utilizing an exemplary ultrasonic apparatus,

FIGS. 3-6 are graphical representations of impact force per mass flow of liquid versus distance.

FIG. 7 is an illustration of a burning spray of No. 2 diesel fuel with no ultrasound applied.

FIG. 8 is an illustration of a similar burning spray of No. 2 diesel fuel with ultrasound applied depicting an increased cone angle.

### DETAILED DESCRIPTION OF THE INVENTION

As used herein, the term “liquid” or “liquid fuel” refers to an amorphous (noncrystalline) form of fuel material intermediate between gases and solids, in which the molecules are much more highly concentrated than in gases, but much less concentrated than in solids. A liquid may have a single component or may be made of multiple components. The components may be other liquids, solid and/or gases. For example, a characteristic of liquids is their ability to flow as a result of an applied force. Liquids that flow immediately upon application of force and for which the rate of flow is directly proportional to the force applied are generally referred to as Newtonian liquids. Some liquids have abnormal flow response when force is applied and exhibit non-Newtonian flow properties.

As used herein, the term “fluid” or “immiscible fluid” refers to an amorphous (noncrystalline) form of material which may include liquids and gases. A fluid may have a single component or may be made of multiple components. The components may be other gases, solids and/or liquids. The term “immiscible” refers to the fluid's property that makes it incapable of mixing or attaining homogeneity with the liquid with which it is combined. For example, water is an immiscible fluid with respect to oil. On the other hand the term “immiscible” does not indicate that the fluid is immiscible with respect to all other liquids, just that it be immiscible with the liquid with which it is to be combined.

As used herein, the term “node” means the point on the longitudinal excitation axis of the ultrasonic horn at which no longitudinal motion of the horn occurs upon excitation by ultrasonic energy. The node sometimes is referred in the art, as well as in this specification, as the nodal point.

The term “close proximity” is used herein in a qualitative sense only. That is, the term is used to mean that the means for applying ultrasonic energy is sufficiently close to the opening of the vestibular cavity to apply the ultrasonic energy primarily to the reservoir of liquid (e.g., fuel admixture) contained within the vestibular cavity. The term is not used in the sense of defining specific distances from the vestibular cavity.

As used herein, the term “consisting essentially of” does not exclude the presence of additional materials which do not significantly affect the desired characteristics of a given composition or product. Exemplary materials of this sort would include, without limitation, pigments, antioxidants, stabilizers, surfactants, waxes, flow promoters, solvents, particulates and materials added to enhance processability of the composition.

Generally speaking, the apparatus of the present invention includes an injector housing and a means for applying ultrasonic energy to a portion of a fuel admixture (e.g., hydrocarbon oils, hydrocarbon emulsions, alcohols, combustible slurries, suspensions or the like). The injector housing in part defines a chamber adapted to receive the pressurized liquid, an inlet (e.g., inlet orifice) or a plurality of inlets adapted to supply the chamber with the pressurized liquid, and an exit orifice (e.g., extrusion orifice) adapted to receive the pressurized liquid from the chamber and pass the liquid out of the exit orifice of the injector housing. The means for applying ultrasonic energy is located within the chamber. For example, the means for applying ultrasonic energy can be located partially within the chamber or the means for applying ultrasonic energy can be located entirely within the chamber.

The apparatus may comprise a single inlet for receiving an admixture of liquid fuel and an immiscible fluid under pressure. Alternatively, the apparatus may also comprise a plurality of inlets. Each inlet could be adapted to provide a single component to the chamber. That is, one inlet could provide fuel under pressure to the chamber, while another separate inlet could provide some additive to the chamber. Likewise, a plurality of inlets could be provided, each one adapted to provide a single component or a multi-component fluid to the chamber.

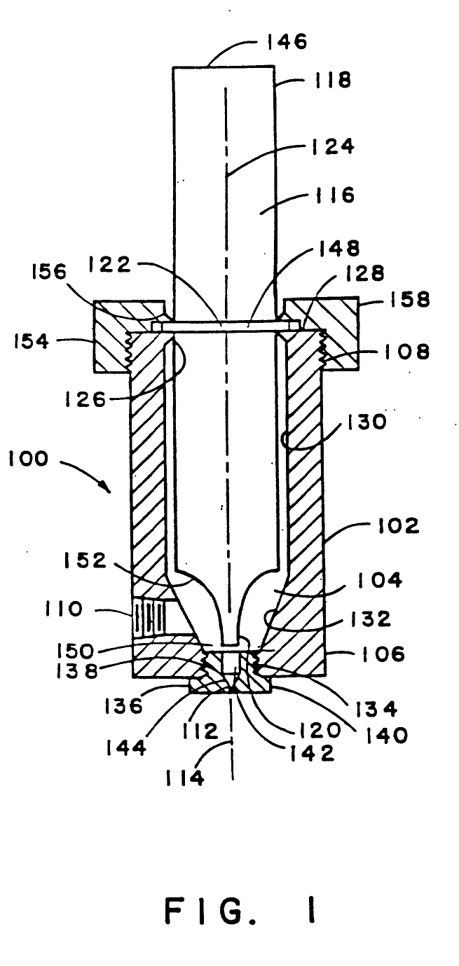

Referring now to FIG. 1, there is shown, not necessarily to scale, an exemplary apparatus for injecting a fuel admixture into a continuous combustor. The apparatus 100 includes an injector housing 102 which partially defines a chamber 104 adapted to receive a fuel admixture. The injector housing 102 has a first end 106 and a second end 108. The injector housing 102 also has an inlet 110 (e.g., inlet orifice) adapted to supply the chamber 104 with the fuel admixture. The first end 106 of the injector housing 102 may terminate in an injector tip 136′. The injector tip 136 may be formed in the first end 106 or alternatively may comprise a separate, interchangeable component as depicted. An exit orifice 112 (which may also be referred to as an extrusion orifice) is located in the injector tip 136; it is adapted to receive the fuel admixture from the chamber 104 and ultimately pass the fuel out of the injector housing 102 along a first axis 114. A vestibular cavity 142 is also located in the injector tip 136 and is disposed between the chamber 104 and the exit orifice 112. The vestibular cavity may be directly connected to the exit orifice 112 or the two may be interconnected via a passageway 144.

An ultrasonic horn 116 is located in the second end 108 of the injector housing 102. The ultrasonic horn has a first end 118 and a second end 120. The horn 116 is adapted, upon excitation by ultrasonic energy, to have a nodal point 122 and a longitudinal mechanical excitation axis 124. The horn 116 is coupled to the injector housing 102 at the nodal point 122. Desirably, the first axis 114 and the mechanical excitation axis 124 will be substantially parallel. More desirably, the first axis 114 and the mechanical excitation axis 124 will substantially coincide, as shown in FIG. 1.

The horn 116 is located in the second end 108 of the injector housing 102 in a manner such that the first end 118 of the horn 116 is located outside of the injector housing 102 and the second end 120 of the horn 116 is located inside the injector housing 102 within the chamber 104. The second end 120 of the horn 116 is positioned in close proximity to the vestibular cavity 142 and is substantially aligned along the longitudinal mechanical excitation axis with a central axis of the vestibular cavity.

The size and shape of the apparatus of the present invention can vary widely, depending, at least in part, on the number and arrangement of exit orifices (e.g., extrusion orifices) and the operating frequency of the means for applying ultrasonic energy. For example, the injector housing may be cylindrical, rectangular, or any other shape. Moreover, the injector housing may have a single exit orifice or a plurality of exit orifices. A plurality of exit orifices may be arranged in a pattern, including but not limited to, a linear or a circular pattern. Each of the exit orifices may be associated with a dedicated vestibular cavity. Likewise, a plurality of exit orifices might be associated with a single vestibular cavity or cavities. Furthermore, the cross-sectional profile of the exit orifice and the orientation of the exit orifice with respect to the longitudinal mechanical excitation axis does not result in a negative impact on the use of the apparatus in a fuel injection system.

The means for applying ultrasonic energy is located within the chamber, typically at least partially surrounded by the fuel admixture, i.e., the chamber includes both at least a portion of the means for applying ultrasonic energy as well as liquid fuel. Such means is adapted to apply the ultrasonic energy to the fuel admixture contained within the vestibular cavity as it is passed to the exit orifice. Stated differently, such means is adapted to apply ultrasonic energy primarily to a portion of the pressurized liquid admixture in the vicinity of the vestibular cavity and each exit orifice. Such means may be located completely or partially within the chamber, preferably within close proximity of the vestibular cavity.

When the means for applying ultrasonic energy is an ultrasonic horn, the horn conveniently extends through the injector housing, such as through the first end of the housing as identified in FIG. 1. However, the present invention comprehends other configurations. For example, the horn may extend through a wall of the injector housing, rather than through an end. Moreover, neither the first axis nor the longitudinal excitation axis of the horn need be vertical. If desired, the longitudinal mechanical excitation axis of the horn may be at an angle to the first axis. Nevertheless, the longitudinal mechanical excitation axis of the ultrasonic horn desirably will be substantially parallel with the first axis. More desirably, the longitudinal mechanical excitation axis of the ultrasonic horn desirably and the first axis will substantially coincide, as shown in FIG. 1.

If desired, more than one means for applying ultrasonic energy may be located within the chamber defined by the injector housing. Moreover, a single means may apply ultrasonic energy to the portion of the fuel admixture which is in the vicinity of one or more exit orifices or is contained within one or more vestibular cavities.

According to the present invention, the ultrasonic horn may be partially or wholly composed of a magnetostrictive material. The horn may be surrounded by a coil (which may be immersed in the liquid) capable of inducing a signal into the magnetostrictive material causing it to vibrate at ultrasonic frequencies. In such cases, the ultrasonic horn can simultaneously be the transducer and the means for applying ultrasonic energy to the multi-component liquid fuel.

The application of ultrasonic energy to a plurality of exit orifices may be accomplished by a variety of methods. For example, with reference again to the use of an ultrasonic horn, the second end of the horn may have a cross-sectional area which is sufficiently large so as to apply ultrasonic energy to the portion of the pressurized liquid which is in the vicinity of all of the exit orifices in the injector housing. In such case, the second end of the ultrasonic horn desirably will have a cross-sectional area approximately the same as or greater than a minimum area which encompasses the area defining the opening to the vestibular cavity in the injector housing. Alternatively, the second end of the horn may have a plurality of protrusions, or tips, equal in number to the number of individual vestibular cavities leading to exit orifices. In this instance, the cross-sectional area of each protrusion or tip desirably will be approximately the same as or less than the cross-sectional area of the vestibular cavity with which the protrusion or tip is in close proximity.

The planar relationship between the second end of the ultrasonic horn and an array of exit orifices may also be shaped (e.g., parabolically, hemispherically, or provided with a shallow curvature) to provide or correct for certain spray patterns.

As already noted, the term “close proximity” is used herein to mean that the means for applying ultrasonic energy is sufficiently close to the area defining the opening to the vestibular cavity leading to the exit orifice to apply the ultrasonic energy primarily to the fuel admixture passing from the vestibular cavity into the exit orifice. The actual distance of the means for applying ultrasonic energy from the exit orifice in any given situation will depend upon a number of factors, some of which are the flow rate and/or viscosity of the fuel admixture, the cross-sectional area of the end of the means for applying the ultrasonic energy relative to the cross-sectional area of the exit orifice, the cross-sectional area of the end of the means for applying the ultrasonic energy relative to the cross-sectional area of the opening to the vestibular portion, the frequency of the ultrasonic energy, the gain of the means for applying the ultrasonic energy (e.g., the magnitude of the longitudinal mechanical excitation of the means for applying ultrasonic energy), the temperature of the pressurized liquid, and the rate at which the liquid admixture is passed out of the exit orifice.

In general, the distance of the means for applying ultrasonic energy from the exit orifice in a given situation may be determined readily by one having ordinary skill in the art without undue experimentation. In practice, such distance will be in the range of from about 0.002 inch (about 0.05 mm) to about 1.3 inches (about 33 mm), although greater distances can be employed. Moreover, the distance between the means for applying ultrasonic energy and the opening of the vestibular cavity can range from about 0 inches (about 0 mm) to about 0.100 inch (about 2.5 mm). It should be noted that the term “about 0 inches” contemplates the condition in which the means for applying ultrasonic energy actually protrudes a distance into the vestibular cavity. It is believed that the distance between the tip of the means for applying ultrasonic energy and the opening of the vestibular cavity determines the extent to which ultrasonic energy is applied to the fuel other than that which is about to enter or is contained within the vestibular cavity; i.e., the greater the distance, the greater the amount of pressurized liquid which is subjected to ultrasonic energy. Consequently, shorter distances generally are desired in order to minimize degradation of the fuel admixture and other adverse effects which may result from exposure of the fuel to the ultrasonic energy. In some embodiments, these distances range from about 0.040 inch (about 1 mm) protrusion into the vestibular cavity to about 0.010 inch (about 0.25 mm) separation between the tip and the vestibular cavity are contemplated. In one desirable embodiment, the tip and the vestibular cavity are separated by a distance of about 0.005 inch (about 0.13 mm).

One advantage of the apparatus of the present invention is that it is self-cleaning. That is, the combination of supplied pressure and forces generated by ultrasonically exciting the means for supplying ultrasonic energy to the fuel admixture (without applying ultrasonic energy directly to the orifice) can remove obstructions that appear to block the exit orifice (e.g., extrusion orifice). According to the invention, the exit orifice is adapted to be self-cleaning when the means for applying ultrasonic energy is excited with ultrasonic energy (without applying ultrasonic energy directly to the orifice) while the exit orifice receives fuel admixture from the chamber via the vestibular cavity and through the passageway, if one is present, and passes the fuel out of the injector housing.

Desirably, the means for applying ultrasonic energy is an immersed ultrasonic horn having a longitudinal mechanical excitation axis and in which the end of the horn located in the injector housing nearest the orifice is in close proximity to the opening of the vestibular cavity in the injector tip, does not intrude into the injector tip and does not apply vibrational energy directly to the exit orifice.

As described above, one aspect of the present invention covers an apparatus for emulsifying a pressurized multi-component liquid fuel. Generally speaking, the emulsifying apparatus has the configuration of the apparatus described above and the exit orifice is adapted to emulsify a pressurized multi-component liquid when the means for applying ultrasonic energy is excited with ultrasonic energy while the exit orifice receives pressurized multi-component liquid fuel from the chamber. A portion of the admixture containing the pressurized multi-component liquid is subjected to ultrasonic energy. The predominant portion of the admixture subjected to ultrasonic energy is contained within the vestibular cavity to which the ultrasonic energy is predominantly directed. The pressurized admixture is then passed from the vestibular cavity to the exit orifice in the injector tip. The admixture is ejected from the exit orifice under pressure in the form of an atomized plume. The particles of this plume contain an emulsification comprising the liquid fuel and the normally immiscible fluid. The structure of the device set forth above eliminates or at least minimizes any mechanical vibrational energy transferred to the nozzle, or injector tip (i.e., the exit orifice(s)) normally associated with the use of an ultrasonically vibrating apparatus.

The present invention also includes a method of emulsifying a pressurized multi-component liquid. The method includes the steps of supplying a pressurized liquid to the injector assembly described above; exciting means for applying ultrasonic energy (located within the injector assembly) with ultrasonic energy while the exit orifice receives fuel admixture from the chamber without applying vibrational energy directly to the exit orifice; and passing the liquid out of the exit orifice in the injector tip so that the liquid is emulsified.

The present invention covers an apparatus for producing a spray of liquid. Generally speaking, the spray-producing apparatus has the configuration of the apparatus described above and the exit orifice is adapted to produce a spray of liquid when the means for applying ultrasonic energy is excited with ultrasonic energy while the exit orifice receives pressurized liquid from the chamber and passes the liquid fuel out of the exit orifice in the injector tip. The apparatus is especially adapted to provide an atomized spray of liquid (i.e., a very fine spray or spray of very-small droplets).

The apparatus may be adapted to produce a uniform, cone-shaped spray or plume of liquid. For example, the apparatus may be adapted to produce a cone-shaped spray of liquid having a relatively uniform density or distribution of droplets throughout the cone-shaped spray. Alternatively, the apparatus may be adapted to produce irregular patterns of spray and/or irregular densities or distributions of droplets throughout the cone-shaped spray. Irregular patterns and/or densities can be created by varying the voltage to the transducer thus affecting the amplitude at which the horn vibrates. The horn can be made to vibrate intermittently and/or changes in amplitude can be made at different frequencies resulting in numerous effects to the spray pattern, spray cone angle, and/or spray density of the liquid fuel.

The present invention also includes a method of producing a spray of liquid. The method includes the steps of supplying a pressurized liquid to the injector assembly described above; exciting means for applying ultrasonic energy (located within the injector assembly) with ultrasonic energy while the exit orifice receives pressurized liquid from the chamber without applying vibrational energy directly to the exit orifice; and passing the liquid out of the exit orifice in the injector tip to produce a spray of liquid. According to the method of the invention, the conditions may be adjusted to produce an atomized spray of liquid, a uniform, cone-shaped spray, irregularly patterned sprays and/or sprays having irregular densities.

The apparatus and method may be used in fuel injectors for liquid-fueled combustors. Exemplary combustors include, but are not limited to, boilers, kilns, industrial and domestic furnaces, incinerators. Many of these combustors use heavy liquid fuels that may be advantageously handled by the apparatus and method of the present invention.

Internal combustion engines present other applications where the apparatus and method of the present invention may be used with fuel injectors. For example, the apparatus and method may be used in fuel injectors for discontinuous flow reciprocating piston gasoline and diesel engines. More particularly, a means for delivering ultrasonic vibrations is incorporated within a fuel injector. The vibrating element is placed so as to be in contact with the fuel as it enters a cavity, i.e., the vestibular cavity, terminating in an exit orifice. The vibrating element is aligned so the axis of its vibrations are parallel with the axis of the orifice. Immediately before the liquid fuel enters the vestibular cavity, the vibrating element in contact with the liquid fuel applies ultrasonic energy to the fuel. Additional energy is applied to the fuel residing within the vestibular cavity.

The vibrations appear to change the apparent viscosity and flow characteristics of high viscosity liquid fuels. The vibrations also appear to improve the flow rate and/or improved atomization of the fuel stream as it enters the cylinder. In fact, it is believed that there are at least two distinct ways in which the device affects atomization of the fuel. First, the application of ultrasonic energy to a coherent stream of liquid fuel having a particular combination of liquid viscosity, pressure, temperature, flow rate, and exit orifice geometry can cause the coherent stream to change to an atomized plume without changing any of the other flow parameters. Second, the application of ultrasonic energy to an existing atomized plume appears to improve (e.g., decrease) the size of liquid fuel droplets, narrow the droplet size distribution of the liquid fuel plume, and increase the included cone angle of the spray pattern. Moreover, application of ultrasonic energy appears to increase the velocity and penetration of liquid fuel droplets exiting the orifice into a combustion chamber. The vibrations also cause breakdown and flushing out of clogging contaminants at the exit orifice. The vibrations can also cause emulsification of the liquid fuel with other components (e.g., liquid or gaseous components) or additives that may be present in the fuel stream or separately supplied to the apparatus.

The apparatus and method may be used in fuel injectors for continuous flow engines such as Sterling heat engines and gas turbine engines. Such gas turbine engines may include torque reaction engines such as aircraft main and auxiliary engines, co-generation plants and other prime movers. Other gas turbine engines may include thrust reaction engines such as jet aircraft engines.

The apparatus and method of the present invention may be used to emulsify multi-component liquid fuels as well as fluid fuel additives and contaminants, whether they be liquid or gaseous, at the point where the liquid fuels are introduced into the combustor (e.g., internal combustion engine). For example, water entrained in certain fuels may be emulsified so that fuel/water mixture may be used in the combustor. Mixed fuels and/or fuel blends including components such as, for example, methanol, water, ethanol, diesel, liquid propane gas, bio-diesel or the like can also be emulsified. The present invention can have advantages in multi-fueled engines in that it may be used to compatibalize the flow rate characteristics (e.g., apparent viscosities) of the different fuels that may be used in the multi-fueled engine.

Alternatively and/or additionally, it may be desirable to add water to one or more liquid fuels and emulsify the components immediately before combustion as a way of controlling combustion and/or reducing exhaust emissions. It may also be desirable to add a gas (e.g., air, N₂O, etc.) to one or more liquid fuels and ultrasonically blend or emulsify the components immediately before combustion as a way of controlling combustion and/or reducing exhaust emissions.

Use of the invention to enhance continuous flow fuel injection systems results in improved droplet sizing and distribution, improved spray cone angle, and significantly improved energy exchange and velocity of the spray plume resulting in greater penetration capability. Furthermore, the range of effectiveness of one attribute (e.g., increased velocity) is not attenuated by a causal factor that tends to attenuate the range of another attribute (e.g., flow rate or droplet size).

The present invention is further described by the examples which follow. Such examples, however, are not to be construed as limiting in any way either the spirit or the scope of the present invention.

### EXAMPLES

Ultrasonic Horn Apparatus

The following is a description of an exemplary ultrasonic horn apparatus of the present invention generally as shown in FIG. 1 incorporating the more desirable features described above.

With reference to FIG. 1, the injector housing 102 of the apparatus was a cylinder having an outer diameter of 1.375 inches (about 34.9 mm), an inner diameter of 0.875 inch (about 22.2 mm), and a length of 3.086 inches (about 78.4 mm). The outer 0.312-inch (about 7.9-mm) portion of the second end 108 of the injector housing was threaded with 16-pitch threads. The inside of the second end had a beveled edge 126, or chamfer, extending from the face 128 of the second end toward the first end 106 a distance of 0.125 inch (about 3.2 mm). The chamfer reduced the inner diameter of the injector housing at the face of the second end to 0.75 inch (about 19.0 mm). An inlet 110 (also called an inlet orifice) was drilled in the injector housing, the center of which was 0.688 inch (about 17.5 mm) from the first end, and tapped. The inner wall of the injector housing consisted of a cylindrical portion 130 and a conical frustrum portion 132. The cylindrical portion extended from the chamfer at the second end toward the first end to within 0.992 inch (about 25.2 mm) from the face of the first end. The conical frustrum portion extended from the cylindrical portion a distance of 0.625 inch (about 15.9 mm), terminating at a threaded opening 134 in the first end. The diameter of the threaded opening was 0.375 inch (about 9.5 mm); such opening was 0.367 inch (about 9.3 mm) in length.

A nozzle or injector tip 136 was located in the threaded opening of the first end. The injector tip consisted of a threaded cylinder 138 having a circular shoulder portion 140. The shoulder portion was 0.125 inch (about 3.2 mm) thick and had two parallel faces (not shown) 0.5 inch (about 12.7 mm) apart. An exit orifice 112 (also called an extrusion orifice) was drilled in the shoulder portion and extended toward the threaded portion a distance of 0.087 inch (about 2.2 mm). The diameter of the extrusion orifice was 0.0145 inch (about 0.37 mm). The extrusion orifice terminated within the injector tip at a vestibular cavity 142 having a diameter of 0.125 inch (about 3.2 mm) and a conical frustrum passage 144 which joined the vestibular cavity with the extrusion orifice. The wall of the conical frustrum passage was at an angle of 30° from the vertical. The vestibular cavity extended from the extrusion orifice to the end of the threaded portion of the injector tip, thereby connecting the chamber defined by the injector housing with the extrusion orifice.

The means for applying ultrasonic energy was a cylindrical ultrasonic horn 116. The horn was machined to resonate at a frequency of 20 kHz. The horn had a length of 5.198 inches (about 132.0 mm), which was equal to one-half of the resonating wavelength, and a diameter of 0.75 inch (about 19.0 mm). The face 146 of the first end 118 of the horn was drilled and tapped for a ⅜-inch (about 9.5-mm) stud (not shown). The horn was machined with a collar 148 at the nodal point 122. The collar was 0.094-inch (about 2.4-mm) wide and extended outwardly from the cylindrical surface of the horn 0.062 inch (about 1.6 mm). Thus, the diameter of the horn at the collar was 0.875 inch (about 22.2 mm). The second end 120 of the horn terminated in a small cylindrical tip 150 0.125 inch (about 3.2 mm) long and 0.125 inch (about 3.2 mm) in diameter. Such tip was separated from the cylindrical body of the horn by a parabolic frustrum portion 152 approximately 0.5 inch (about 13 mm) in length. That is, the curve of this frustrum portion as seen in cross-section was parabolic in shape. The face of the small cylindrical tip was normal to the cylindrical wall of the horn and was located about 0.005 inch (about 0.13 mm) from the opening to the vestibular cavity. Thus, the face of the tip of the horn, i.e., the second end of the horn, was located immediately above the opening to the vestibular cavity in the threaded end of the injector tip.

The first end 108 of the injector housing was sealed by a threaded cap 154 which also served to hold the ultrasonic horn in place. The threads extended upwardly toward the top of the cap a distance of 0.312 inch (about 7.9 mm) . The outside diameter of the cap was 2.00 inches (about 50.8 mm) and the length or thickness of the cap was 0.531 inch (about 13.5 mm). The opening in the cap was sized to accommodate the horn; that is, the opening had a diameter of 0.75 inch (about 19.0 mm). The edge of the opening in the cap was a chamfer 156 which was the mirror image of the chamfer at the second end of the injector housing. The thickness of the cap at the chamfer was 0.125 inch (about 3.2 mm), which left a space between the end of the threads and the bottom of the chamfer of 0.094 inch (about 2.4 mm), which space was the same as the length of the collar on the horn. The diameter of such space was 1.104 inch (about 28.0 mm). The top 158 of the cap had drilled in it four ¼-inch diameter×¼-inch deep holes (not shown) at 90° intervals to accommodate a pin spanner. Thus, the collar of the horn was compressed between the two chamfers upon tightening the cap, thereby sealing the chamber defined by the injector housing.

A Branson elongated aluminum waveguide having an input:output mechanical excitation ratio of 1:1.5 was coupled to the ultrasonic horn by means of a ⅜-inch (about 9.5-mm) stud. To the elongated waveguide was coupled a piezoelectric transducer, a Branson Model 502 Converter, which was powered by a Branson Model 1120 Power Supply operating at 20 kHz (Branson Sonic Power Company, Danbury, Conn.). Power consumption was monitored with a Branson Model A410A Wattmeter.

### Example 1

This example illustrates the present invention as it relates to producing a spray of a hydrocarbon oil that may be used as pressurized liquid fuel. The procedure was conducted utilizing the same ultrasonic device (immersed horn) as Example 1 set up in the same configuration with the following exceptions:

Two different orifices were used. One had a diameter of 0.004 inch and a length of 0.004 inch (L/D ratio of 1) and the other had a diameter of 0.010 and a length of 0.006 inch (L/D ratio of 0.006/0.010 or 0.6).

The oil used was a vacuum pump oil having the designation HE-200, Catalog # 98-198-006 available from Legbold-Heraeus Vacuum Products, Inc. of Export, Pa. The trade literature reported that the oil had a kinematic viscosity of 58.1 centipoise (cP) at 104° Fahrenheit (40° C.) and a kinematic viscosity of 9.14 cP at 212° Fahrenheit (100° C.).

Flow rate trials were conducted on the immersed horn with the various tips without ultrasonic power, at 80 watts of power, and at 90 watts of power. Results of the trials are shown in Table 5. In Table 5, the “Pressure” column is the pressure in psig, the “TIP” column refers to the diameter and the length of the capillary tip (i.e., the exit orifice) in inches, the “Power” column refers to power consumption in watts at a given power setting, and the “Rate” column refers to the flow rate measured for each trial, expressed in g/min. In every trial when the ultrasonic device was powered, the coherent oil stream instantly atomized into a uniform, cone-shaped spray of fine droplets.

TABLE 1
Vacuum Pump Oil HE-200

| | TIP | | | |
|---|---|---|---|---|
| Pressure | Diameter × Length (inches) | | Power | Rate |
| 150 | 0.004 | 0.004 | 0 | 11.8 |
| 150 | | | 80 | 12.6 |
| 150 | | | 90 | 16.08 |
| 250 | 0.004 | 0.004 | 0 | 13.32 |
| 250 | | | 80 | 14.52 |
| 250 | | | 90 | 17.16 |
| 150 | 0.010 | 0.006 | 0 | 20.76 |
| 150 | | | 80 | 22.08 |
| 150 | | | 90 | 25.80 |
| 250 | 0.010 | 0.006 | 0 | 24.00 |
| 250 | | | 80 | 28.24 |
| 250 | | | 90 | 31.28 |

### Example 2

This example illustrates the present invention as it relates to the emulsification of disparate liquids such as oil and water. In this example, an emulsion was formed from water and a hydrocarbon-based oil. The oil chosen for the trials was a petroleum-based viscosity standard oil obtained from the Cannon Instrument Company of State College, Pa., standard number N1000, lot # 92102.

The oil was pressurized and supplied by the pump, drive motor, and motor controller as described above. In this case the output from the pump was connected to one leg of a ¼″ tee fitting. The opposite parallel leg of the tee fitting was connected to the entrance of a six element ½″ diameter ISG Motionless Mixer obtained from Ross Engineering, Inc. of Savannah, Ga. The outlet of the mixer was connected to the inlet of the immersed horn ultrasonic device (See FIG. 1). Water was metered into the oil stream by a piston metering pump. The pump consisted of a 9/16″ diameter by 5″ stroke hydraulic cylinder. The piston rod of the cylinder was advanced by a jacking screw driven by a variable speed motor through reduction gears. The speed of the motor was controlled utilizing a motor controller. The water was routed from the cylinder to the third leg of the tee by a flexible hose. The outlet end of the flexible hose was fitted with a length of stainless steel hypodermic tubing of about 0.030″ inside diameter which, with the flexible hose installed to the tee, terminated in the approximate center of the oil flow stream (upstream of the ultrasonic device).

The immersed horn device was fitted with the 0.0145″ diameter tip. The oil was pressurized to about 250 psig., creating a flow rate of about 35 g/min. The metering pump was set at about 3 rpm resulting in a water flow rate of 0.17 cc/min. Samples of the extrudate (i.e., the liquid output from the ultrasonic device) were taken with no ultrasonic power, and at about 100 watts ultrasonic power. The samples were examined with an optical microscope. The sample that passed through the ultrasonic device while it was unpowered contained widely dispersed water droplets ranging from about 50-300 micrometers in diameter. The sample that passed through the ultrasonic device while it received 100 watts of power (i.e., the ultrasonically treated sample) was an emulsion that contained a dense population of water droplets ranging from about 5 to less than 1 micrometer in diameter.

### Example 3

This example illustrates the present invention as it relates to the size and characteristics of droplets in a plume of No. 2 diesel fuel injected into the atmosphere utilizing the ultrasonic apparatus described above. Diesel fuel was fed to the ultrasonic apparatus utilizing the pump, drive motor, and motor controller as described above. Tests were conducted at pressures of 250 psig and 500 psig, with and without applied ultrasonic energy.

The diesel fuel was injected into ambient air at 1 atmosphere of pressure. All test measurements of the diesel fuel plume were taken at a point 60 mm below the bottom surface of the nozzle, directly below the nozzle. The nozzle was a plain orifice in the form of a capillary tip having an diameter of 0.006 inch and a length of 0.024 inch. The frequency of the ultrasonic energy was 20 kHz and the transducer power (in watts) were read from the power controller and recorded for each test.

Droplet size was measured utilizing a Malvern Droplet and Particle Sizer, Model Series 2600C, available from Malvern Instruments, Ltd., Malvern, Worcestershire, England. A typical spray includes a wide variety of droplet sizes. Difficulties in specifying droplet size distributions in sprays have led to use of various expressions of diameter. The particle sizer was set to measure the drop diameter and report it as the Sauter mean diameter (SMD, also referred to as D₃₂) which represents the ratio of the volume to the surface area of the spray (i.e., the diameter of a droplet whose surface to volume ratio is equal to that of the entire spray).

The droplet velocity is reported as a mean velocity in units of meters per second and was measured utilizing an Aerometrics Phase Doppler Particle Analyzer available from Aerometrics Inc., Mountain View, Calif. The Phase Doppler Particle analyzer was composed of a Transmitter—Model No. XMT-1100-4S; a Receiver—Model No. RCV-2100-1; and a Processor—Model No. PDP-3200. The results are reported in Table 2.

TABLE 2

| Run | Pressure | Transducer Power | SMD (um) | Velocity (m/s) |
|---|---|---|---|---|
| 1 | 250 PSIG | 0 watts | 87.0 | 33.9 |
| 2 | 250 PSIG | 0 watts | 86.9 | 33.6 |
| 3 | 250 PSIG | 87.5 watts | 41.1 | 39.2 |
| 4 | 250 PSIG | 87.5 watts | 40.8 | 38.2 |
| 5 | 500 PSIG | 0 watts | 43.4 | 40.4 |
| 6 | 500 PSIG | 0 watts | 46.8 | 41.2 |
| 7 | 500 PSIG | 102 watts | 41.0 | 56.3 |
| 8 | 500 PSIG | 102 watts | 40.9 | 56.5 |

As may be seen from the results reported in Table 2, the velocity of liquid fuel droplets may be at least about 25 percent greater than the velocity of identical pressurized liquid fuel droplets out of an identical injector housing through an identical exit orifice in the absence of excitation by ultrasonic energy. For example, the velocity of pressurized liquid fuel droplets can be at least about 35 percent greater than the velocity of droplets of an identical pressurized liquid fuel out of an identical injector housing through an identical exit orifice in the absence of excitation by ultrasonic energy. Droplet velocity is generally thought to be associated with the ability of a spray plume to penetrate and disperse in a combustion chamber, especially if the atmosphere in the chamber is pressurized.

In addition to affecting droplet velocity, application of ultrasonic energy can help reduce individual droplet size and size distribution. Generally speaking, it is thought that small sized fuel droplets of a relatively narrow size distribution will tend to burn more uniformly and cleanly than very large droplets. As can be seen from Table 2, the Sauter mean diameter of fuel droplets can be at least about 5 percent smaller than the Sauter mean diameter of droplets of an identical pressurized liquid fuel out of an identical injector housing through an identical exit orifice in the absence of excitation by ultrasonic energy. For example, the Sauter mean diameter of fuel droplets can be at least about 50 percent smaller than the Sauter mean diameter of droplets of an identical pressurized liquid fuel out of an identical injector housing through an identical exit orifice in the absence of excitation by ultrasonic energy.

### Example 4

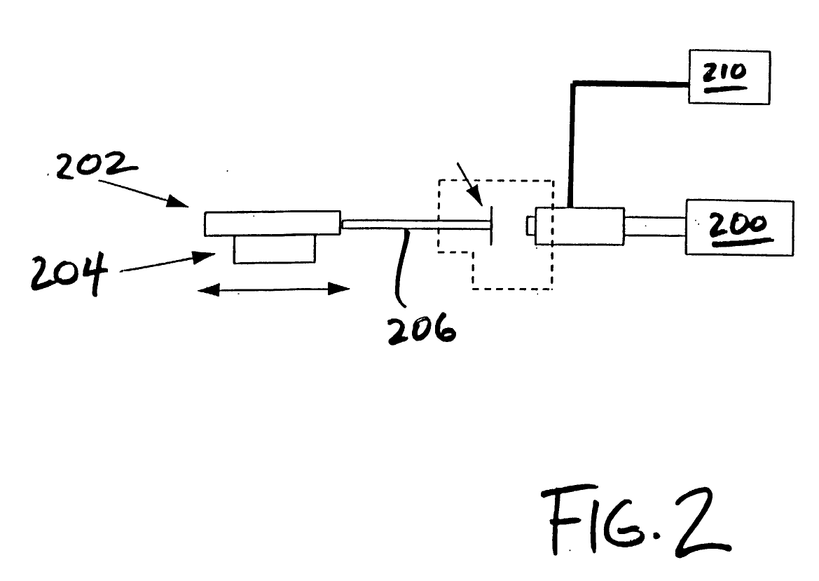

This example illustrates the present invention as it relates to the force or impulse of the droplets in a water plume injected into the atmosphere utilizing the ultrasonic apparatus described above. Referring now to FIG. 2 of the drawings, the 20 kHz ultrasonic apparatus 200 described above was mounted in a horizontal position. The capillary tip used in these trials had a constant diameter of 0.015″ for a length of 0.010″, then the walls diverged at 7° for an additional 0.015″ of length to the exit making a total length of 0.025″. A force gage 202, model ML 4801-4 made by the Mansfield and Green division of the Ametek Company of Largo, Fla., was positioned with its input axis coincidental with the discharge axis of the capillary tip. The force gage was mounted on a standard micrometer slide mechanism 204 oriented to move the gage along its input axis. The input shaft 206 of the gage was fitted with a 1″ diameter plastic target disk 208. In operation, the target disk was positionable from 0.375″ to 1.55″ from the outlet of the capillary tip. Water was pressurized by a water pump 210 (Chore Master pressure washer pump made by the Mi-T-M Corporation of Peosta, Iowa). Water flow rate was measured using a tapered tube flowmeter serial # D-4646 made by the Gilmont Instruments, Inc.

For a given set of conditions, the trials proceeded as follows. The target disk was positioned from the capillary tip in increments of 0.10″. Next, the ultrasonic power supply, if used, was preset to the desired power level, Next the water pump was started, and the desired pressure established. Next ultrasonic power, if used, was turned on. Readings were then taken of power in watts, flow rate in raw data, and impact force in grams. The raw data is reported in Table 3.

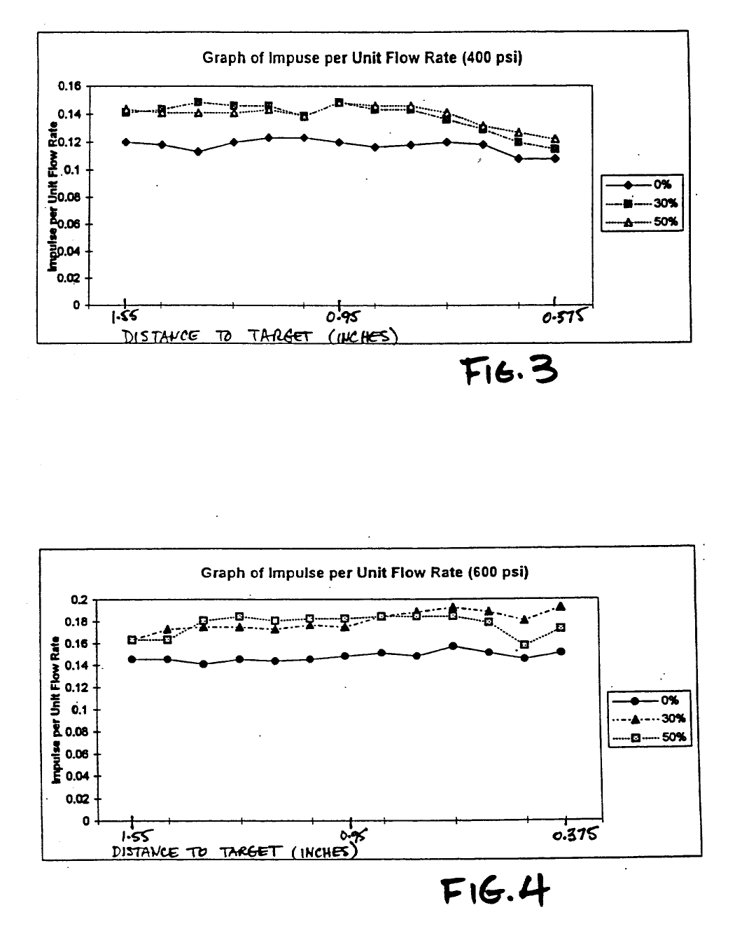

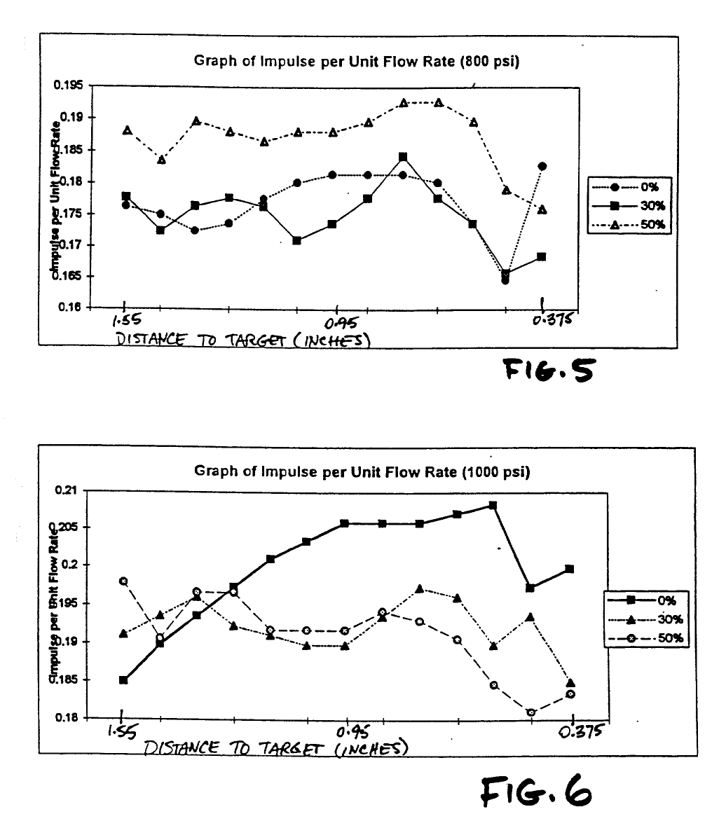

The data was normalized to represent force in grams per unit of mass flow. The normalized data is reported in Table 4. The normalized data indicate that the addition of ultrasonic energy causes an increase in impact force per mass flow of water. This appears to be directly translatable to an increase in velocity of individual droplets in a spray plume. This normalized data is shown graphically in FIGS. 3 through 6. In particular, FIG. 3 is a plot of impact force per mass flow of water versus distance to target at 400 psig. FIG. 4 is a plot of impact force per mass flow of water versus distance to target at 600 psig. FIG. 5 is a plot of impact force per mass flow of water versus distance to target at 800 psig. FIG. 6 is a plot of impact force per mass flow of water versus distance to target at 1000 psig.

As the pressure in the trials approached 1000 psi. the power delivered by the power supply dropped off drastically, an indication that the ultrasonic assembly had shifted resonance to a point beyond the ability of the power supply to compensate. The impact effect for these trials (i.e., at 1000 psig) was diminished.

TABLE 3
RAW DATA - PLUME IMPACT STUDY

| Power | Press. | Flow | Flow | Power | Distance to Target | | | | | | | | | | | | |
|---|---|---|---|---|---|---|---|---|---|---|---|---|---|---|---|---|---|
| Set | psig | Raw | L/min | Watt | 1.55″ | 1.45″ | 1.35″ | 1.25″ | .15″ | 1.05″ | 0.95″ | 0.85″ | 0.75″ | 0.65″ | 0.55″ | 0.45″ | 0.375″ |
| 0% | 1000 | 78 | 0.811 | 0 | 150 | 154 | 157 | 160 | 163 | 165 | 167 | 167 | 167 | 168 | 169 | 160 | 162 |
| 30% | 1000 | 78 | 0.811 | 125 | 155 | 157 | 159 | 156 | 155 | 154 | 154 | 157 | 160 | 159 | 154 | 157 | 150 |
| 50% | 1000 | 80 | 0.834 | 250 | 165 | 159 | 164 | 164 | 160 | 160 | 160 | 162 | 161 | 159 | 154 | 151 | 153 |
| 0% | 800 | 75 | 0.777 | 0 | 137 | 136 | 134 | 135 | 138 | 140 | 141 | 141 | 141 | 140 | 135 | 128 | 142 |
| 30% | 800 | 73 | 0.754 | 120 | 134 | 130 | 133 | 134 | 133 | 129 | 131 | 134 | 139 | 134 | 131 | 125 | 127 |
| 50% | 800 | 65 | 0.659 | 375 | 124 | 121 | 125 | 124 | 123 | 124 | 124 | 125 | 127 | 127 | 125 | 118 | 116 |
| 0% | 600 | 67 | 0.683 | 0 | 99 | 99 | 96 | 99 | 98 | 99 | 101 | 103 | 101 | 107 | 103 | 99 | 103 |
| 30% | 600 | 53 | 0.515 | 225 | 84 | 89 | 90 | 90 | 89 | 91 | 90 | 95 | 97 | 99 | 97 | 93 | 99 |
| 50% | 600 | 53 | 0.515 | 400 | 84 | 84 | 93 | 95 | 93 | 94 | 94 | 95 | 95 | 95 | 92 | 81 | 89 |
| 0% | 400 | 58 | 0.575 | 0 | 69 | 68 | 65 | 69 | 71 | 71 | 69 | 67 | 68 | 69 | 68 | 62 | 62 |
| 30% | 400 | 45 | 0.418 | 200 | 59 | 60 | 62 | 61 | 61 | 58 | 62 | 60 | 60 | 57 | 54 | 50 | 48 |
| 50% | 400 | 45 | 0.418 | 325 | 60 | 59 | 59 | 59 | 60 | 58 | 62 | 61 | 61 | 59 | 55 | 53 | 51 |

TABLE 4
THRUST/ML/MIN

| | Distance to Target (inches) | | | | | | | | | | | | |
|---|---|---|---|---|---|---|---|---|---|---|---|---|---|
| Power | 1.55 | 1.45 | 1.35 | 1.25 | 1.15 | 1.05 | 0.95 | 0.85 | 0.75 | 0.65 | 0.55 | 0.45 | 0.38 |

Pressure 1000 psig

| | | | | | | | | | | | | | |
|---|---|---|---|---|---|---|---|---|---|---|---|---|---|
| 0% | 0.185 | 0.19 | 0.194 | 0.197 | 0.201 | 0.203 | 0.206 | 0.21 | 0.21 | 0.207 | 0.21 | 0.197 | 0.2 |
| 30% | 0.191 | 0.194 | 0.196 | 0.192 | 0.191 | 0.19 | 0.19 | 0.19 | 0.2 | 0.196 | 0.19 | 0.194 | 0.18 |
| 50% | 0.198 | 0.191 | 0.197 | 0.197 | 0.192 | 0.192 | 0.192 | 0.19 | 0.19 | 0.191 | 0.18 | 0.181 | 0.18 |

Pressure 800 psig

| | | | | | | | | | | | | | |
|---|---|---|---|---|---|---|---|---|---|---|---|---|---|
| 0% | 0.176 | 0.175 | 0.172 | 0.174 | 0.178 | 0.18 | 0.181 | 0.18 | 0.18 | 0.18 | 0.17 | 0.165 | 0.18 |
| 30% | 0.178 | 0.172 | 0.176 | 0.178 | 0.176 | 0.171 | 0.174 | 0.18 | 0.18 | 0.178 | 0.17 | 0.166 | 0.17 |
| 50% | 0.188 | 0.184 | 0.19 | 0.188 | 0.187 | 0.188 | 0.188 | 0.19 | 0.19 | 0.193 | 0.19 | 0.179 | 0.18 |

Pressure 600 psig

| | | | | | | | | | | | | | |
|---|---|---|---|---|---|---|---|---|---|---|---|---|---|
| 0% | 0.145 | 0.145 | 0.141 | 0.145 | 0.143 | 0.145 | 0.148 | 0.15 | 0.15 | 0.157 | 0.15 | 0.145 | 0.15 |
| 30% | 0.163 | 0.173 | 0.175 | 0.175 | 0.173 | 0.177 | 0.175 | 0.18 | 0.19 | 0.192 | 0.19 | 0.181 | 0.19 |
| 50% | 0.163 | 0.163 | 0.181 | 0.184 | 0.181 | 0.183 | 0.183 | 0.18 | 0.18 | 0.184 | 0.18 | 0.157 | 0.17 |

Pressure 400 psig

| | | | | | | | | | | | | | |
|---|---|---|---|---|---|---|---|---|---|---|---|---|---|
| 0% | 0.12 | 0.118 | 0.113 | 0.12 | 0.123 | 0.123 | 0.12 | 0.12 | 0.12 | 0.12 | 0.12 | 0.108 | 0.11 |
| 30% | 0.141 | 0.144 | 0.148 | 0.146 | 0.146 | 0.139 | 0.148 | 0.14 | 0.14 | 0.136 | 0.13 | 0.12 | 0.11 |
| 50% | 0.144 | 0.141 | 0.141 | 0.141 | 0.144 | 0.139 | 0.148 | 0.15 | 0.15 | 0.141 | 0.13 | 0.127 | 0.12 |

### Example 5

This example illustrates the present invention as it relates to the size characteristics of droplets in a plume of No. 2 diesel fuel injected into the atmosphere utilizing the ultrasonic apparatus described above. Diesel fuel was fed to the ultrasonic apparatus utilizing the pump, drive motor, and motor controller as described above. Tests were conducted at pressures from 100 psig to 1000 psig (in increments of 100 psig) with and without applied ultrasonic energy.

The diesel fuel was injected into ambient air at 1 atmosphere of pressure. All test measurements of the diesel fuel plume were taken at a point 50 mm below the bottom surface of the nozzle, directly below the nozzle. The nozzle was a plain orifice in the form of a capillary tip having an diameter of 0.006 inch and a length of 0.024 inch. The tip of the ultrasonic horn was located 0.075 inch from the opening in the capillary tip. The frequency of the ultrasonic energy, volts, current were read from the power meter and recorded for each test. The watts used were calculated from available data.

Droplet size was measured utilizing a Malvern Droplet and Particle Sizer, Model Series 2600C, available from Malvern Instruments, Ltd., Malvern, Worcestershire, England. A typical spray includes a wide variety of droplet sizes. Difficulties in specifying droplet size distributions in sprays have led to the use of various expressions of diameter. The particle sizer was set to measure the drop diameter such that 50% of total liquid volume is in drops of smaller diameter (D_{0.5}); the drop diameter such that 90% of total liquid volume is in drops of smaller diameter (D_{0.9}); and the Sauter mean diameter (SMED, also referred to as D₃₂) which represents the ratio of the volume to the surface area of the spray (i.e., the diameter of a droplet whose surface to volume ratio is equal to that of the entire spray). The results are reported in Table 5.

TABLE 5
Droplet Size

| Pres- | Fre- | | | | | 50% | 90% |
|---|---|---|---|---|---|---|---|
| sure | quency | Volts | Current | Watts | SMD | Size | Size |
| (psig) | (kHz) | (volts) | (amps) | (calc.) | (um) | (um) | (um) |
| 100 | 19.88 | 189.9 | 1.065 | 202.2 | 37.61 | 50.23 | 83.79 |
| 100 | 19.88 | 189.9 | 1.065 | 202.2 | 38.48 | 51.41 | 86.38 |
| 100 | 0 | 0 | 0 | 0 | 295.19 | 355.96 | 517.05 |
| 100 | 0 | 0 | 0 | 0 | 301.79 | 370.29 | 520.98 |
| 200 | 19.84 | 223.1 | 1.058 | 236.0 | 25.52 | 35.32 | 60.99 |
| 200 | 19.84 | 223.1 | 1.058 | 236.0 | 26.57 | 36.32 | 61.94 |
| 200 | 0 | 0 | 0 | 0 | 167.38 | 275.85 | 492.53 |
| 200 | 0 | 0 | 0 | 0 | 188.81 | 261.95 | 483.32 |
| 300 | 19.83 | 235.9 | 1.124 | 265.1 | 27.57 | 39.23 | 69.68 |
| 300 | 19.83 | 235.9 | 1.124 | 265.1 | 27.93 | 39.73 | 70.56 |
| 300 | 0 | 0 | 0 | 0 | 135.87 | 244.13 | 479.05 |
| 300 | 0 | 0 | 0 | 0 | 147.80 | 247.30 | 480.97 |
| 400 | 19.83 | 257.4 | 1.203 | 309.7 | 23.74 | 34.11 | 61.20 |
| 400 | 19.83 | 257.4 | 1.203 | 309.7 | 23.74 | 34.11 | 61.20 |
| 400 | 0 | 0 | 0 | 0 | 114.84 | 234.58 | 476.21 |
| 400 | 0 | 0 | 0 | 0 | 110.83 | 232.97 | 475.85 |
| 500 | 19.82 | 280.9 | 1.294 | 363.5 | 23.54 | 33.21 | 58.48 |
| 500 | 19.82 | 280.9 | 1.294 | 363.5 | 23.54 | 33.21 | 58.48 |
| 500 | 0 | 0 | 0 | 0 | 67.99 | 137.98 | 327.17 |
| 500 | 0 | 0 | 0 | 0 | 67.99 | 137.98 | 327.17 |
| 600 | 19.83 | 265.3 | 1.235 | 327.6 | 23.89 | 35.86 | 67.22 |
| 600 | 19.83 | 265.3 | 1.235 | 327.6 | 22.90 | 34.85 | 66.30 |
| 600 | 0 | 0 | 0 | 0 | 61.07 | 132.14 | 327.75 |
| 600 | 0 | 0 | 0 | 0 | 59.53 | 126.07 | 306.33 |
| 700 | 19.82 | 298.9 | 1.364 | 407.7 | 20.12 | 31.54 | 62.10 |
| 700 | 19.82 | 298.9 | 1.364 | 407.7 | 20.67 | 31.97 | 61.98 |
| 700 | 0 | 0 | 0 | 0 | 51.36 | 113.51 | 284.40 |
| 700 | 0 | 0 | 0 | 0 | 51.36 | 113.51 | 284.40 |
| 800 | 19.83 | 286.7 | 1.322 | 379.0 | 19.75 | 31.92 | 64.99 |
| 800 | 19.83 | 286.7 | 1.322 | 379.0 | 19.75 | 31.92 | 64.99 |
| 800 | 0 | 0 | 0 | 0 | 41.57 | 93.38 | 234.49 |
| 800 | 0 | 0 | 0 | 0 | 41.57 | 93.38 | 234.49 |
| 900 | 19.82 | 299.6 | 1.361 | 407.8 | 17.63 | 29.35 | 62.29 |
| 900 | 19.82 | 299.6 | 1.361 | 407.8 | 17.63 | 29.35 | 62.29 |
| 900 | 0 | 0 | 0 | 0 | 27.08 | 53.62 | 130.24 |
| 900 | 0 | 0 | 0 | 0 | 26.89 | 56.73 | 146.30 |
| 1000 | 19.82 | 312.0 | 1.390 | 433.7 | 15.51 | 29.57 | 75.74 |
| 1000 | 19.82 | 312.0 | 1.390 | 433.7 | 15.51 | 29.57 | 75.74 |
| 1000 | 0 | 0 | 0 | 0 | 24.47 | 54.45 | 150.39 |
| 1000 | 0 | 0 | 0 | 0 | 25.03 | 54.71 | 147.76 |

As can be seen from Table 5, the apparatus and method of the present invention can produce significant reduction in the Sauter mean diameter, D_{0.9} and D_{0.5}. This effect appears to diminish at higher pressures, primarily due to shifting resonance of the ultrasonic assembly beyond the ability of the power supply to compensate.

### Example 6

Continuous flow combustion experiments were conducted to determine what effects the ultrasonic-injector technology had on combustion and soot emissions. These tests were carried out at an injection pressure of 2,050 psig. The equipment comprised a 4,000-psig cylinder filled with nitrogen gas (N₂) coupled to a 2,200-psig rated cylinder filled No. 2 diesel fuel. N₂ gas was regulated to 2,050 psig and occupied the void volume in the 2,200-psig cylinder via a tee connection, thus pressurizing the diesel fuel. The combustor test section was pressurized to 90 psig and heated to 1,030° F. (where steady auto-ignition occurred).

No mass flow rate data for these tests were recorded because the flow rate at 2,050 psig was well beyond the range of the rotameter used in the atomization experiments. However, based on mass continuity and Bernoulli's equation for an incompressible fluid, the flow rate was on the order of 70 lbm/hr.

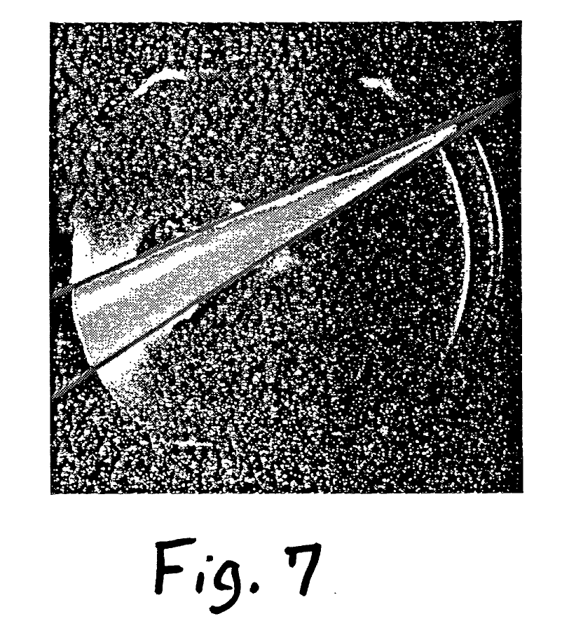

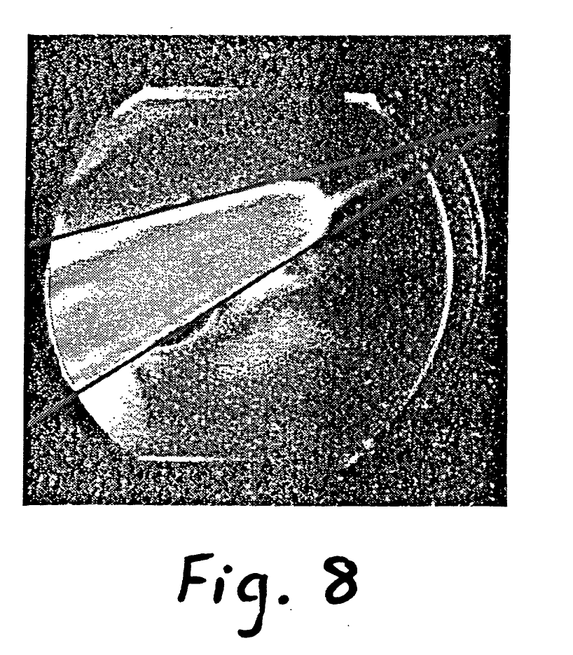

A video camera was used to record the luminosity of the flame's reflection off of a piece of glass with a black backing. Several minutes of testing were recorded, using various optical filters to reduce the flame's luminosity and prevent over-exposure of the film. During the tests, No. 2 diesel fuel was allowed to enter the preheated and pressurized test section, at which time auto-ignition would ensue. As shown in FIG. 7, the resulting flame appeared very unstable as it spanned the entire diameter of the optical window, flickering like a flag in the wind. This flame also appeared detached from the nozzle tip by approximately 2 inches.

When ultrasound was activated, as shown in FIG. 8, the flame quickly stabilized and seemingly attached itself to the nozzle tip. In other words, fuel droplets burned almost immediately after issuing from the nozzle tip and the resulting flame appeared steady. The most significant observation was a nearly two-fold increase in cone angle. and a less defined air-fuel interface at the edge of the flame. FIGS. 7 and 8 indicate that the cone angle was approximately 150 for the no ultrasound case, and 250 for the ultrasound case. The not as well defined air-fuel interface indicates better mixing.

Because both flames spanned the entire diameter of the optical window, no analysis of flame temperature for soot concentrations could be performed for a representative comparison. However, it was determined that that the application of ultrasound results in mixing times about 41 percent less than the mixing time without ultrasonics. Reduced mixing times have been shown in other tests to reduce soot emissions.

### Related Applications

This application is one of a group of commonly assigned patent applications which are currently pending before the Patent and Trademark Office including one being filed on the same date. The group includes application Ser. No. 08/576,543 entitled “An Apparatus And Method For Emulsifying A Pressurized Multi-Component Liquid”, Docket No. 12535, in the name of L. K. Jameson et al.; application Ser. No. 08/576,522 entitled “Ultrasonic Fuel Injection Method And Apparatus”, Docket No. 12537, in the name of L. H. Gipson et al.; application Ser. No. ______, filed on Dec. 11, 2000, entitled “Unitized Injector Modified for Ultrasonically Stimulated Operation”, Docket No. KCX-371 in the name of L. Jameson et al.; and application Ser. No. ______, filed on Dec. 11, 2000, entitled “Ultrasonic Fuel Injector with Ceramic. Valve Body”, Docket No. KCX-372 in the name of L. Jameson et al.; The subject matter of these applications is hereby incorporated by reference.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A fuel injection apparatus adapted to emulsify an immiscible fluid with a pressurized liquid fuel at the point of injection into a combustion chamber comprising:
a chamber adapted to receive an admixture containing a pressurized liquid fuel and an immiscible fluid;
at least one inlet adapted to supply the chamber with a combination of the pressurized liquid fuel and the immiscible fluid; and
a fuel injector tip comprising a vestibular cavity and at least one exit orifice, the vestibular cavity interconnected with the exit orifice, the vestibular cavity adapted to receive the admixture from the chamber and to pass the admixture to the exit orifice, the exit orifice adapted to eject the admixture out of the exit orifice in the form of an atomized plume into the combustion chamber; and
a means for applying ultrasonic energy to the admixture within the vestibular cavity without mechanically vibrating the injector tip, wherein the means for applying ultrasonic energy is located within the chamber in close proximity to the vestibular cavity and serves to emulsify the admixture prior to its ejection from the exit orifice.

2. The apparatus of claim 1, wherein the means for applying ultrasonic energy is an immersed ultrasonic horn.

3. The apparatus of claim 1, wherein the means for applying ultrasonic energy is an immersed magnetostrictive ultrasonic horn.

4. The apparatus of claim 1, wherein the exit orifice is a plurality of exit orifices.

5. The apparatus of claim 1, wherein the exit orifice is a single exit orifice.

6. The apparatus of claim 1, wherein the exit orifice has a diameter of from about 0.0001 to about 0.1 inch.

7. The apparatus of claim 6, wherein the exit orifice has a diameter of from about 0.001 to about 0.01 inch.

8. The apparatus of claim 1, wherein the exit orifice is an exit capillary.

9. The apparatus of claim 8, wherein the exit capillary has a length to diameter ratio of from about 4:1 to about 10:1.

10. The apparatus of claim 1, wherein the ultrasonic energy has a frequency of from about 15 kHz to about 500 kHz.

11. The apparatus of claim 1, wherein the ultrasonic energy has a frequency of from about 15 kHz to about 100 kHz.

12. The apparatus of claim 1, further comprising a plurality of inlets wherein each inlet supplies the chamber with at least one component of the admixture.

13. A fuel injection apparatus adapted to emulsify an immiscible fluid with a pressurized liquid fuel at the point of injection into a combustion chamber comprising:
a fuel injector nozzle further comprising;
at least one exit orifice; and
a vestibular cavity, the vestibular cavity interconnected with the exit orifice, and adapted to receive an admixture containing a pressurized liquid fuel and an immiscible fluid; and
a means for applying ultrasonic energy to the admixture of liquid fuel and immiscible fluid within the vestibular cavity, the means being located in close proximity to the vestibular cavity;
wherein the application of ultrasonic energy serves to emulsify the admixture prior to its ejection from the exit orifice without mechanically vibrating the exit orifice.

14. The apparatus of claim 13, wherein the ultrasonic energy has a frequency of from about 15 kHz to about 500 kHz.

15. The apparatus of claim 13, wherein the means for applying ultrasonic energy further comprises a tip having a cross-sectional area approximately the same as or less than a minimum area which encompasses the area defining the opening to the vestibular cavity in the injector tip.

16. The apparatus of claim 13, wherein the means for applying ultrasonic energy comprises an ultrasonic horn having coupled to a first end thereof a vibrator means as a source of longitudinal mechanical excitation.

17. The apparatus of claim 16, wherein the vibrator means is a piezoelectric transducer.

18. The apparatus of claim 16, wherein the vibrator means is a magnetostrictive transducer.

19. The apparatus of claim 17, wherein the piezoelectric transducer is coupled to the ultrasonic horn by means of an elongated waveguide.

20. The apparatus of claim 19, wherein the elongated waveguide has an input:output mechanical excitation ratio of from about 1:1 to about 1:2.5.

21. The apparatus of claim 13, wherein the means for applying ultrasonic energy is an immersed magnetostrictive ultrasonic horn.

22. A method of emulsifying an immiscible fluid with a pressurized liquid fuel at the point of injection into a combustion chamber, the method comprising:
supplying a fuel admixture to a fuel injector assembly, the fuel injector assembly comprising:
a chamber adapted to receive an admixture containing a pressurized liquid fuel and an immiscible fluid;
at least one inlet adapted to supply the chamber with a combination of the pressurized liquid fuel and the immiscible fluid; and
a fuel injector tip comprising a vestibular cavity and at least one exit orifice, the vestibular cavity interconnected with the exit orifice, the vestibular cavity adapted to receive the admixture from the chamber and to pass the admixture to the exit orifice, the exit orifice adapted to eject the admixture out of the fuel injector tip; and
a means for applying ultrasonic energy to a portion of the admixture within the vestibular cavity without mechanically vibrating the injector tip, wherein the means for applying ultrasonic energy is located within the chamber in close proximity to the vestibular cavity;
exciting the means for applying ultrasonic energy with ultrasonic energy while the vestibular cavity receives the admixture from the chamber and passes it to the exit orifice; and
passing the fuel admixture out of the exit orifice in the fuel injector tip in the form of an emulsified, atomized plume.

23. The method of claim 22 wherein the means for applying ultrasonic energy is located within the chamber.

24. The method of claim 22, wherein the means for applying ultrasonic energy is an immersed ultrasonic horn.

25. The method of claim 22, wherein the means for applying ultrasonic energy is an immersed magnetostrictive ultrasonic horn.

26. The method of claim 22, wherein the exit orifice is an exit capillary.

27. The method of claim 22, wherein the ultrasonic energy has a frequency of from about 15 kHz to about 500 kHz.

28. The method of claim 22, wherein the ultrasonic energy has a frequency of from about 15 kHz to about 60 kHz.

29. The method of claim 22, wherein the velocity of liquid fuel droplets contained within the admixture is at least about 25 percent greater than the velocity of identical liquid fuel droplets out of an identical fuel injector assembly through an identical exit orifice in the absence of excitation by ultrasonic energy.

30. The method of claim 22, wherein the velocity of liquid fuel droplets contained within the admixture is at least about 35 percent greater than the velocity of droplets of an identical fuel droplets out of an identical fuel injector assembly through an identical exit orifice in the absence of excitation by ultrasonic energy.

31. The method of claim 22, wherein the Sauter mean diameter of liquid fuel droplets contained within the admixture is at least about 5 percent smaller than the Sauter mean diameter of droplets of an identical fuel admixture out of an identical fuel injector assembly through an identical exit orifice in the absence of excitation by ultrasonic energy.

32. The method of claim 22, wherein the Sauter mean diameter of liquid fuel droplets contained within the admixture is at least about 50 percent smaller than the Sauter mean diameter of droplets of an identical fuel admixture out of an identical fuel injector assembly through an identical exit orifice in the absence of excitation by ultrasonic energy.

33. A method of emulsifying an immiscible fluid with a pressurized liquid fuel at the point of injection into a combustion chamber, the method comprising:
supplying a fuel admixture to a fuel injector apparatus comprising:
a fuel injector nozzle further comprising at least one exit orifice and a vestibular cavity, the vestibular cavity interconnected with the exit orifice, and adapted to receive an admixture containing a pressurized liquid fuel and an immiscible fluid; and
a means for applying ultrasonic energy to the 20 admixture of liquid fuel and immiscible fluid within the vestibular cavity, the means being located in close proximity to the vestibular cavity;
exciting the ultrasonic horn with ultrasonic energy while the exit orifice ejects the fuel admixture from the apparatus in the form of an emulsified, atomized plume without mechanically vibrating the exit orifice.

34. The method of claim 33, wherein the exit orifice is an exit capillary.

35. The method of claim 34, wherein the ultrasonic energy has a frequency of from about 15 kHz to about 500 kHz.
